(19) United States
(12) Patent Application Publication
(10) Pub. No.: US 2006/0000541 A1
(43) Pub. Date: Jan. 5, 2006

(54) Method of masking or protecting a substrate

(75) Inventors: Patrick J. Hager, Woodbury, MN (US); Jeffrey R. Janssen, Woodbury, MN (US); Michael R. Gorman, Lake Elmo, MN (US); Jeffrey O. Emslander, Afton, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/883,110

(22) Filed: Jul. 1, 2004

(51) Int. Cl. B32B 37/00; B32B 3/06

(52) U.S. Cl. 156/66; 156/272.6; 428/99

(57) ABSTRACT

A method of protecting a substrate using a protection sheet is disclosed. The protection sheet comprises a multilayer structure having a support layer and a thermoplastic backing layer, wherein the support layer contains a plurality of raised portions and a plurality of anchor portions bonded to a surface of the backing layer. The raised portions of the protection sheet are capable of releasably engaging with a mechanical mating member. In an embodiment, the backing layer of the protection sheet is surface treated to increase wetting tension to facilitate the adherence of paint particles to the surface of the protection sheet. The protection sheet may be used to protect horizontal substrates, vertical substrates, and objects, such as the walls of a paint booth, a work surface and a vehicle.

### FIELD OF THE INVENTION

The present invention relates to masking materials and methods of masking or protecting a substrate. The invention also relates to substrates protected by the methods of the present invention.

### BACKGROUND OF THE INVENTION

In collision repair facilities, painting operations are often carried out in paint booths in order to contain the paint overspray produced during the painting operation. Once contaminated with paint overspray, the walls of the paint booths can be difficult and time consuming to clean. Paint booths may also be heated to dry or cure the paint finish, making the removal of baked-on paint from the booth walls even more burdensome. In addition, cleaning the unprotected walls of a paint booth may take up to a day or more, resulting in significant booth down-time.

To address this problem, various means of covering the surfaces of paint booths have been developed, such as sprayable coatings and plastic sheeting.

Sprayable coatings made from water-soluble polymeric materials are relatively easy to install, but cumbersome and time-consuming to remove. Typically, such coatings are to be removed every week or so by methods such as peeling or power washing. However, due to the difficulty of removal, the coatings often remain in place for longer periods of time, enduring multiple bake cycles with temperatures up to or in excess of 160° F. Under these conditions, the solubility of the coatings decrease, further complicating the removal process. In addition, washable coatings present environmental concerns when the washings are discarded into common drains or municipal waste water systems.

Adhesive coated plastic sheets are difficult to install and generally must be cut around each protrusion in the paint booth each time they are applied. These systems often develop wrinkles, which provide surfaces for the collection of particulates that are easily dislodged and may form nibs or defects in the paint coating. In addition, upon exposure to heat, the adhesive strength of the materials increases making removal of the sheets difficult.

Auto repair facilities additionally have the need to cover or protect work surfaces from oil, dirt and debris. Further, such facilities have the need to cover or protect automobiles from exposure to outdoor and indoor conditions, which may cause damage to the automobile.

### SUMMARY OF THE INVENTION

The present invention is directed to a method of masking or protecting a substrate and substrates protected by such a method. In an embodiment, a method of protecting a substrate is disclosed comprising the steps of: (a) providing at least one fastener adhered to the substrate wherein the fastener has at least one mechanical mating member; (b) providing a protection sheet, which comprises a backing layer and a support layer, wherein the backing layer is characterized by a wetting tension of at least 35 dynes/cm, and the support layer is characterized by a plurality of anchor portions bonded to the protection sheet and a plurality of raised portions, raised from the surface of the backing layer by comparison to the anchor portions, the raised portions having surface features that can releasably engage or interlock with the mechanical mating member of the fastener; and (c) adhering the support layer of the protection sheet to the mechanical mating member of the fastener to cover the substrate.

In an embodiment, the mechanical mating member is selected from a plurality of fibers and a plurality of stems, and the raised portions of the support layer comprise surface features selected from a plurality of fibers and a plurality of stems.

In an embodiment of the invention, the backing layer comprises a polymer surface that has been treated by a process selected from flame treatment, corona treatment, and treatment with liquid or polymeric coatings. In an embodiment, the backing layer is treated with a nitrogen corona treatment.

In a further embodiment, the invention is directed to a method of protecting a substrate comprising the steps of: (a) providing a fastener having a front surface and an opposing back surface, the front surface of the fastener having a plurality of outwardly projecting hook members, the back surface of the fastener having an adhesive layer; (b) adhering the back surface of the fastener to the substrate; (c) providing a protection sheet of material, the protection sheet having a multi-layer structure comprising a support layer and an opposing backing layer; the support layer including a plurality of longitudinally oriented fibers having anchor portions and raised portions projecting in a direction away from the anchor portions, the backing layer is adhered onto the anchor portions of the fibers to bond the anchor portions such that the longitudinally oriented fibers of the support layer are adhered to the backing layer in a corrugated fashion, the backing layer having a wetting tension of at least 35 dynes/cm; and (d) adhering the support layer of the protection sheet of material to the hook members of the fastener to cover the substrate.

In yet a further embodiment, the invention is directed to a method of protecting a substrate comprising: (a) providing a protection sheet having a multi-layer structure comprising a support layer and an opposing backing layer, the support layer including a plurality of fibers having anchor portions and raised portions projecting in a direction away from the anchor portions, and wherein the backing layer is adhered to the anchor portions of the fibers to bond the anchor portions such that the fibers of the support layer are adhered to the backing layer in a corrugated fashion; and (b) covering the substrate with the protection sheet.

In another embodiment, the invention is directed to the combination of a substrate and a protection sheet fastened to the substrate, comprising: (a) the substrate; (b) at least one fastener adhered to the substrate, the fastener having at least one mechanical mating member; and (c) the protection sheet, which comprises a backing layer and a support layer, the backing layer characterized by a wetting tension of at least 35 dynes/cm, and the support layer being characterized by a plurality of anchor portions bonded to the protection sheet and a plurality of raised portions, raised from the surface of the backing layer by comparison to the anchor portions, said raised portions having surface features that can releasably engage or interlock with the mechanical mating member of the fastener causing the protection sheet to adhere to the fastener.

### BRIEF DESCRIPTION OF THE DRAWINGS

The present invention will be further described with reference to the accompanying drawings wherein like reference numerals refer to like parts in the several views, and wherein:

FIG. 1 is a perspective view of a protection sheet in an embodiment of the invention;

FIG. 2 is a perspective view of a roll of the protection sheet of FIG. 1;

FIG. 3 is a perspective view of a mechanical fastener in an embodiment of the invention;

FIG. 4 illustrates a method of protecting a vertical substrate in an embodiment of the invention;

FIG. 5 illustrates a paint booth having walls covered with a protection sheet of an embodiment of the present invention;

FIG. 6 illustrates a method of protecting a horizontal substrate in an embodiment of the present invention; FIG. 7 is a perspective view of a vehicle covered with a protection sheet in an embodiment of the present invention;

FIGS. 8a and 8b illustrate protection sheets in further embodiments of the present invention.

### DETAILED DESCRIPTION OF THE INVENTION

The present invention is directed to a method of masking or protecting a substrate and substrates protected by such a method. In its most basic form, the invention relates to a method of protecting a substrate using a protection sheet where the protection sheet may or may not be adhered to the surface of the substrate. The substrates to be protected may be a vertical surface such as a wall, a horizontal surface, such as a floor or bench top, or an object, such as a vehicle.

In an embodiment, the protection sheet of the present invention comprises a multilayer structure including a backing layer and a support layer. The backing layer provides protection to the substrate, and is made of a durable, moisture-resistant, and optionally UV resistant thermoplastic material. In an embodiment, the surface of the backing layer is treated to increase wetting tension to facilitate the adherence of paint particles to the surface of the backing layer.

The support layer is made of a material which contains a plurality of raised portions and plurality of anchor portions, wherein the raised portions have surface features which are capable of releasably engaging or interlocking with the surface of a mechanical mating member. The anchor portions of the support layer are intermittently bonded to the backing layer of the protection sheet wherein the bonding pattern may be random or regular.

In an embodiment of the invention, a method of covering a horizontal substrate such as a workbench is disclosed, wherein the protection sheet is used with the support layer outwardly exposed. In this embodiment, the raised portions of the support layer provide increased surface area to contain liquids, particulates, and the like, while the backing layer prevents liquids from penetrating the protection sheet and reaching the substrate.

In a further embodiment of the invention, the protection sheet is used to protect and object, such as a vehicle, wherein the protection sheet is used with the support layer placed against the object, and the backing layer is outwardly exposed.

The protection sheet may be secured to a substrate by the use of a fastener such as a mechanical mating member or an adhesive. As used herein “mechanical mating member” refers to any device such as hooks and loops, suction cups, magnets, and the like which is capable of releasably securing articles together. “Adhesive” refers to a tacky substance capable of holding two materials together. The permanency of the bond created by an adhesive may vary based on the type of adhesive used.

In one embodiment of the invention, the protection sheet is utilized with a fastener to cover a vertical substrate, such as the walls of a paint booth. The protection sheet is cut to an appropriate size and adhered to the walls of the paint booth with the fastener. The plurality of raised portions on the support layer of the protection sheet are capable of releasably interlocking with a fastener having a mechanical mating member such as a plurality of hooks.

Thus, the protection sheet is easy to install, as the support layer of the protection sheet acts as a mechanical mating member, which will interlock with a complimentary mating member attached to the substrate.

The raised portions of the support layer of the protection sheet further provide smooth coverage over uneven surfaces. When placed against a substrate to be protected, the structure and height of the support layer material provides compensation for uneven surfaces, such that the exposed backing layer is relatively free of sharp deformations. This is beneficial when the protection sheet is used in masking operations, as a smooth surface facilitates the adherence of paint to the surface of the backing layer.

In an embodiment, the protection sheet comprises a support layer having a plurality of fibers having anchor portions bonded or fused into the backing layer at spaced bonding locations, and arcuate portions projecting from the front surface of the backing layer, such that the support layer is bonded to the backing layer in a corrugated fashion. The arcuate portions of the support layer provide a “loop” surface capable of mating with a plurality of hooks. U.S. Pat. No. 5,256,231 (Gorman et al.), the entire content of which is incorporated by reference herein, describes a method of manufacturing a protection sheet having such a structure.

In the procedure, a non-woven sheet of longitudinally oriented fibers is formed with a carding machine. The sheet of fibers, while lacking internal bonding, has sufficient integrity to be fed from the carding machine into a pair of corrugating members. The corrugating members may be any apparatus capable of facilitating intermittent bonding of the sheet of fibers to a backing layer. In an embodiment, the corrugating members are a pair of heated rollers, each having a plurality of ridges around its periphery with the ridges having outer surfaces defining spaces between the ridges, which are adapted to receive portions of the ridges of the other corrugating member, such that the corrugating members are in meshing relationship with one another.

At least one of the corrugating members is rotated and the sheet of fibers is fed between the meshed portions of the ridges of the corrugating members, which conforms the sheet of fibers to the periphery of the first corrugating member with the raised portions of the sheet of fibers being formed in the spaces between the ridges, and the anchor portions being formed at the ridges.

A thermoplastic backing layer is then bonded onto the anchor portions of the corrugated sheet of fibers. The backing layer may be bonded onto the sheet of fibers in any suitable manner, such as laminating a pre-formed polymer film onto the sheet of fibers, or extrusion of a molten polymer blend onto the sheet of fibers. In an embodiment, the backing layer is extruded onto the anchor portions of the sheet of fibers, such that the anchor portions of the sheet of fibers become fused into the backing sheet.

In an embodiment, the backing layer is surface treated to improve the adherence of paint particles to the surface of the backing layer. The surface treatment may be any suitable treatment that increases the wetting tension of the surface of the backing layer. Suitable treatments to increase the wetting tension include, by way of non-limiting example, corona treatment, flame treatment and the use of liquid or polymeric coatings. Examples of liquid coatings include ethylene vinyl acetate dispersions, alkyd resins in organic solvent, acrylate and urethane acrylate coatings in water or organic solvents, polyvinyl chloride in an organic solvent, and all of the previously mentioned liquids combined with inorganic materials such as talc, clays, silica and pigments.

Examples of polymeric coatings include ethylene vinyl acetate polymers, acrylate modified ethylene vinyl acetate polymers, vinyl chloride polymers, neutralized ethylene acrylic acid polymers, and all of the previously mentioned polymers combined with inorganic materials such as talc, clays, silica and pigments.

In an embodiment, a nitrogen corona treatment with a maximum oxygen content of 100 parts per million (ppm) is used. “Nitrogen corona treatment” as used herein, is also known by the terms atmospheric-pressure nitrogen dielectric-barrier discharge, nitrogen corona discharge, nitrogen barrier discharge, atmospheric-pressure nitrogen plasma, atmospheric pressure nitrogen glow discharge, atmospheric pressure nonequilibrium nitrogen plasma, silent nitrogen discharge, and the like. A specific method of carrying out nitrogen corona treatment is disclosed in co-pending patent application Ser. No. ______ (file number 59819) assigned to present assignee, the entire contents of which are incorporated by reference herein.

In an embodiment, the resultant wetting tension of the treated backing layer is at least about 35 dynes/cm. In a further embodiment, the wetting tension is at least about 40 dynes/cm. Wetting tension, as used herein, may be measured by the procedure outlined in ASTM D 2578-04.

The backing layer of the protection sheet may also contain color additives or printing. Color additives such as titanium dioxide, fillers or pigments may be used to impart neutral coloring to the protection sheet to facilitate color matching in painting operations. For example, color additives that impart a bright white or dull gray finish may be used to assist repair shops in color matching, by providing a consistent uniform background to view the vehicle paint color. The surface treated backing material is particularly well suited to printing, and the backing layer may be imprinted with graphics, logos, lettering and the like.

Turning now to the drawings, FIG. 1 illustrates the structure of a protection sheet 10 of one embodiment of the present invention. The protection sheet 10 is shown having a backing layer 12 constructed of a thermoplastic material, and a support layer 14 constructed from a sheet of oriented fibers 16. The sheet of oriented fibers 16 contains raised portions 18 and anchor portions 20, wherein the anchor portions 20 are bonded to the backing layer 12 at bonding locations 22 intermittently spaced along the length of the backing layer 12. In one aspect of this embodiment, the raised portions 18 of the sheet of fibers 16 form an arcuate structure 24, such that the sheet of fibers 14 are bonded to the backing layer 12 in a corrugated fashion.

In a further aspect of this embodiment, the raised portions 18 of the sheet of fibers 16 have a generally uniform height from the backing layer 12 of less than about 0.64 centimeters (0.25 inches). In a further aspect, the height of the raised portions 18 is less than about 0.381 centimeters (0.150 inches). In a further embodiment, the height of the raised portions 18 is at least one third of the distance between the bonding locations 22 of the anchor portions 20, and in another embodiment, the height of the raised portions is between one-half to one and one-half times the distance between bonding locations 22.

The individual fibers used to construct the support layer 14 are less than 25 denier in one embodiment, and between 1 and 10 denier in a further embodiment. The basis weight of the sheet of fibers 16 (excluding the backing) is about 5 to 300 grams per square meter in one embodiment, and about 15 to 100 grams per square meter in another embodiment.

In a further embodiment of the invention, the sheet of fibers 16 has a basis weight of about 75 to 150 grams per square meter and the individual fibers are up to about 32 denier in size. The higher basis weight and denier of the fibers in this embodiment enables a greater number of engagements and disengagements with a mechanical mating member before failure of the fiber material.

The sheet fibers 16 of the support layer 14 may be made of a variety of materials such as polypropylene, polyethylene, polyester, nylon or polyamide, or combinations of materials such as a core of polyester and a sheath of polypropylene, which provides relatively high strength due to its core material, and is easily bonded due to its sheath material. Fibers of one material or fibers of different materials may be used in the same sheet of fibers 16.

The thermoplastic backing layer 12 may be bonded onto the anchor portions 20 of the sheet of fibers 16 in any suitable manner, such as laminating a pre-formed polymer film onto the sheet of fibers 16, or extrusion of a molten polymer blend onto the anchor portions 20 of the sheet of fibers 16. In an embodiment, the backing layer 12 is extruded onto the anchor portions 20 of the sheet of fibers 16 and bonded at bonding locations 22.

The backing layer 12 may be made of a single layer of polymeric material such as polypropylene, polyethylene, ethylene vinyl acetate, polyester, polyamide, or mixtures thereof. Alternatively, the backing layer 12 may be made of a plurality of layers such as, by way of non-limiting example, a central layer of a relatively high strength material such as polyester, a second layer of ethylene vinyl acetate or polyethylene and a third layer of a polymer such as polyethylene. In one embodiment, the thickness of the backing layer 12 is at least about 0.00125 centimeters (0.005 inches).

The protection sheet 10 may be supplied in the form of a roll 30, as depicted in FIG. 2, from which the required amount of material may be cut for use. In an embodiment, a roll of 1.7 meters wide by 50 meters long is provided. For ease of use, the protection sheet may be perforated along a line parallel to the axis of the roll to facilitate the removal of a predetermined length of the protection sheet (not shown).

The protection sheet may be adhered to a substrate with a fastener. Virtually any mechanical or adhesive fastener capable of releasably attaching the protection sheet to a substrate may be used. In an embodiment, a mechanical fastener comprising a strip of hook members is used. U.S. Pat. No. 5,845,375 (Miller et al.), incorporated by reference in its entirety herein, describes a mushroom-type hook strip for a mechanical fastener that is suitable for use in the present invention. The hook strip comprises a backing of a thermoplastic resin, and integral with the backing, a plurality of stems projecting from the backing with heads at the ends of the stems opposite the backing. In an embodiment, the stems are generally circular in cross section. Other suitable shapes such as rectangular and hexagonal cross-sections may be used. The head portion of the stems may also take on a variety of shapes. In an embodiment, the heads are in the form a circular disk.

In general, the hooks are of uniform height. In an embodiment, the hooks are about 0.10 to 1.27 mm in height, and have a density on the backing from about 60 to about 1,550 hooks per square centimeter. The stem diameter adjacent the heads of the hooks is about 0.076 to about 0.635 mm, and the circular disc-like heads project radially past the stems by about 0.013 to about 0.254 mm.

In an embodiment, the hook strip is made of a highly oriented polymer material, which gives the stems of the hook strip enhanced strength, thus reducing the likelihood of breakage under disengagement forces. This is advantageous since broken hooks can create debris, which is highly undesirable in painting operations. Further, a loop surface typically contains many more loops than there are hooks per unit area, thus a stronger hook stem allows for a greater number of disengagements before a hook-and-loop fastener becomes useless.

The strip of hook members may be made from a variety of thermoplastic materials, which are suitable for extrusion molding. Examples of such materials which are suitable to produce the hook strip are polyesters such as poly(ethylene terephthalate), polyamides such as nylon, poly(styrene-acrylonitrile), poly(acrylonitrile-butadiene-styrene), polyolefins such as polypropylene, and plasticized polyvinyl chloride. In an embodiment, the hook strip is made from a thermoplastic resin comprising a random copolymer of polypropylene and polyethylene containing 15% polyethylene and having a melt flow index of 15, commercially available under the trade designation “Dow 7C05N” from Dow Chemical Company, Midland Mich.

The hook strip may contain a layer of an adhesive on its surfaces opposite the hooks with which the backing may be adhered to a substrate. Many adhesives would be suitable for use with the strip of hook material. In an embodiment, a pressure sensitive adhesive is used. Such an adhesive is commercially available from the 3M Company, St. Paul, Minn., under the trade designation “Command.” The hook strip can be produced in long webs that can be wound up as rolls for convenient storage and shipment.

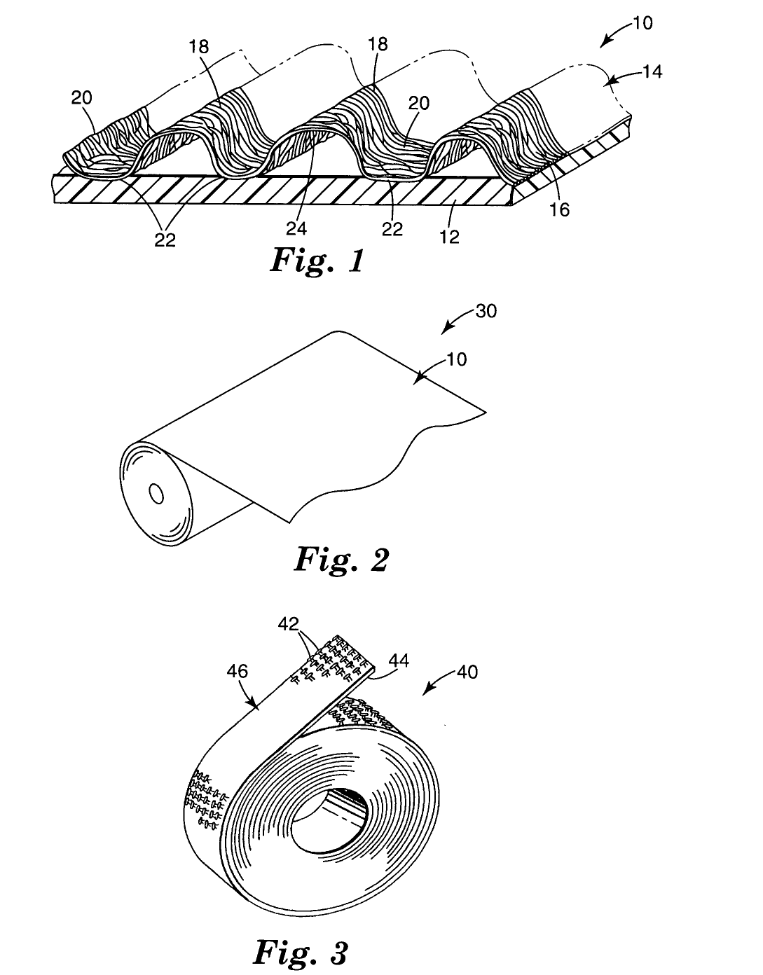

Turning now to FIG. 3, an example of hook material in the form of a roll of tape 40 is shown. A layer of pressure sensitive adhesive on the surface of the backing 44 is releasably adhered to the heads of the hooks 42 on underlying wraps of the hook strip 46 in the roll 40, thus not requiring a release liner to protect the layer of pressure sensitive adhesive in the roll 40. The limited area of the heads 42 to which the pressure sensitive adhesive is adhered in the roll 40 maintains the hook strip 46 in the roll until it is ready for use. In an embodiment, a roll 10 centimeters wide by 36 meters in length is provided, in a further embodiment, a roll 5 centimeters wide by 36 meters in length is provided, and in yet a further embodiment, a roll 2.54 centimeters wide by 36 meters in length is provided. It should be appreciated that multiple dimensions of the roll of hook tape would be suitable to practice the invention, and the specific dimensions provided herein are merely exemplary.

Similar to the roll of protection sheet material 30, the roll of hook tape 40 may be perforated along a line parallel to the axis of the roll to facilitate removal of a predetermined length of tape (not shown). Alternatively, the fastener material could be provided as die cut segments of material stacked upon one another (also not shown). In this embodiment, the segments of fastener material may be provided with an adhesive layer opposite the surface of the mechanical mating member, with several horizontally or vertically oriented pre-cut segments of material stacked upon one another. In this embodiment, the user could simply remove a segment of fastener material without having to cut or tear the segment off of a larger roll of material. This configuration of fastener material may provide greater ease of use for applying the fastener material around protruding areas, or when covering a bench top or a vehicle.

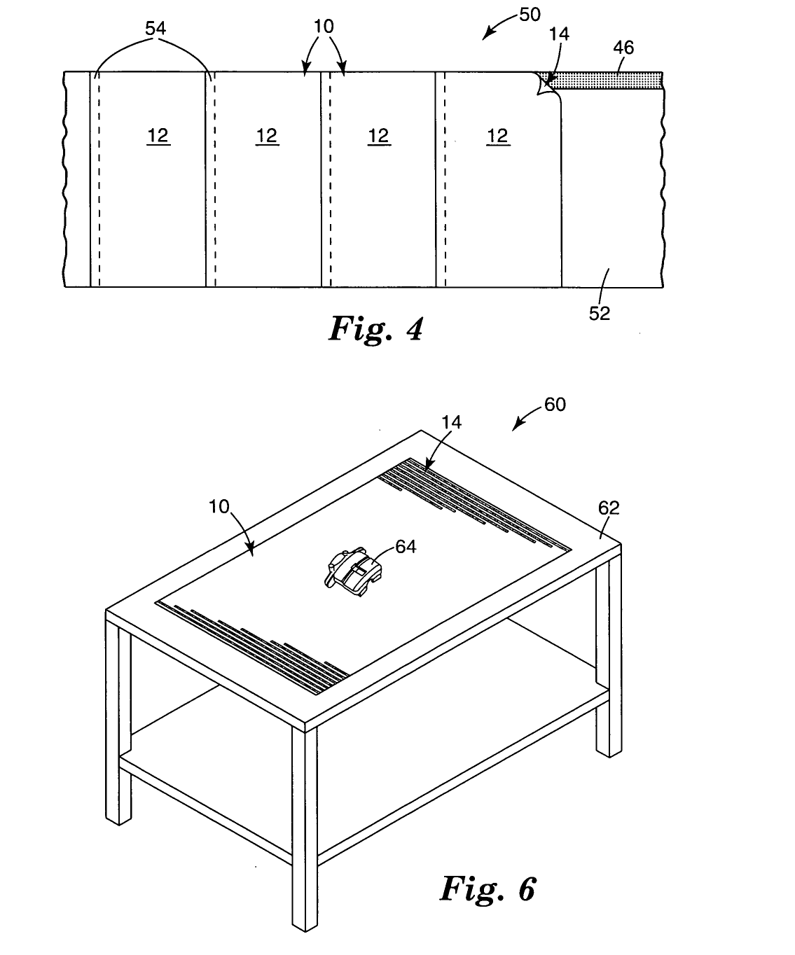

FIG. 4 shows several pieces of the protection sheet 10 attached to a vertical substrate 52, such as the wall of a paint booth, by use of an adhesive-backed strip of hook tape 46. In an embodiment of the invention, a vertical substrate 52 is covered by first adhering a strip of hook tape 46 to the surface of a substrate 52, cutting an appropriately sized piece of the protection sheet 10, and attaching an edge of the support layer 14 of the protection sheet 10 to the hook tape 46. In a further aspect of this embodiment, the protection sheet 10 is installed onto the substrate 52 with overlapping sections 54 which ensure protection of the substrate near adjacent pieces of the protection sheet. In a further aspect of this embodiment, the overlapping sections 54 are about one inch (2.54 cm) wide. To further ensure that the protection sheet 10 stays in place, hook tape 46 may be also placed at the bottom or lateral edges of the protection sheet (not shown.)

In an embodiment, the substrate may be treated to assist in the adhesion of the hook tape 46 or other fastener to the substrate. In some embodiments, the hook tape 46 or other fastener may not contain and adhesive on a surface opposite the mechanical mating member. Various forms of materials may be used to assist in the adhesion of the fastener, for example, an adhesive material applied in the form of a spray. An example of such a material is available under the trade designation “Super 77” available from 3M Company, St. Paul, Minn.

The exposed surface of the backing layer 12 provides protection to the substrate as it is impervious to liquids, and in an embodiment, the surface of the backing layer is treated to increase wetting tension, facilitating the adherence of paint to the surface of the backing 12.

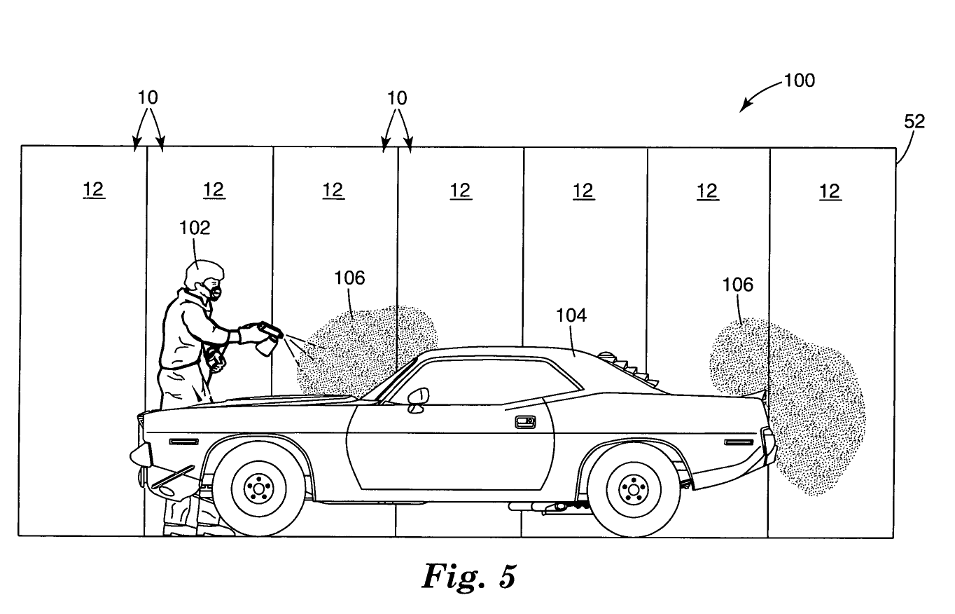

FIG. 5 shows a paint booth 100 with segments of the protection sheet 10 covering the walls 52 of the paint booth. An operator 102 is shown painting a car 104 inside the booth, wherein the paint overspray 106 adheres to the treated surface 12 of the protection sheet 10. Once the painting operation is complete, the protection sheet 10 may stay in place during bake cycles, as the protection sheet is resistant to thermal shrinkage up to temperatures of about 180° F. Once painting and curing are complete, the protection sheet 10 may be easily removed and discarded.

FIG. 6 illustrates an alternate use of the protection sheet 10 as a cover for a horizontal substrate 62, such as a workbench. In this embodiment, the protection sheet 10 may or may not be adhered to the substrate 62 with a fastener. In an embodiment, the protection sheet 10 is used with the support layer 14 facing outward, wherein the raised portions 18 of the sheet of fibers 16 act to absorb or wick oils or fluids which may leak from items 64 placed on the protection sheet 10. The liquid impermeable backing material of the protection sheet 10 prevents liquids from penetrating onto the substrate 62.

FIG. 7 illustrates the use of a protection sheet 10 to cover an article, for example, a vehicle 72, to protect it from the environment. When used to cover a vehicle 72, the protection sheet 10 is used with the support layer 14 placed against the vehicle 72 and the backing layer 12 outwardly exposed. The support layer 14 of the protection sheet 10 protects the paint finish from damage, while the liquid impermeable backing layer 12 protects the vehicle from rain and moisture. The backing layer is also impervious to sun rays, thus protecting the vehicle from UV damage. This is particularly useful to protect the vehicle 72 interior from fading when the vehicle 72 is missing a window.

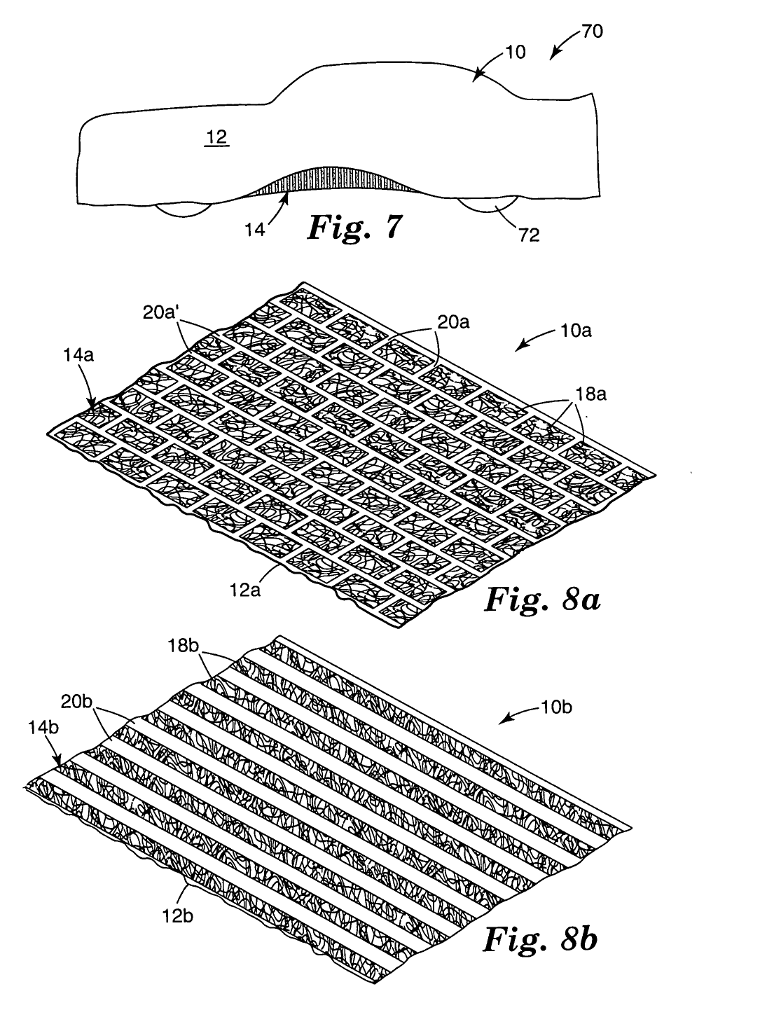

FIGS. 8a and 8b show alternate embodiments of protection sheets 10a and 10b with various arrangements for intermittently bonding the support layer 14a, 14b to the backing layer 12a, 12b. FIG. 8a shows a sheet of randomly oriented fibers bonded at intermittent lateral bonding portions 20a and longitudinal bonding portions 20a′. The raised portions 18a of the support layer 14a are in the form of alternating rectangular portions. It should be appreciated that the raised portions 18a of the protection sheet could be arranged in virtually any shape or pattern. FIG. 8b shows a protection sheet 10b having a support layer 14b comprising randomly oriented fibers with longitudinally displaced raised portions 18b and anchor portions 20b.

### EXAMPLES

Unless otherwise noted, all parts, percentages, and ratios reported in the following examples are on a weight basis. Unless noted differently, all reagents used in the examples were obtained, or are available, from general chemical suppliers such as the Sigma-Aldrich Chemical Company, Saint Louis, Mo., or may be synthesized by conventional techniques.

The following abbreviations are used in the Examples:
“BC1”: a 2:1 basecoat formulation of paints commercially available under the trade designations, respectively, “DBC9700” and “DT870” from PPG Industries, Pittsburgh, Pa.;
“CC1”: a 4:1:1 clearcoat formulation, commercially available under the trade designations, respectively, “DCU2021”, “DCX61” and “DT870” from PPG Industries;
“PR1”: a 3:1:0.5 primer formulation, commercially available under the trade designations, respectively, “NCP271”, “NCX275” and “DT870” from PPG Industries.

A protection sheet according to the present invention was made generally according to the method described in U.S. Pat. No. 5,256,231. Cut 4 denier polypropylene fibers, 50 mm long, commercially available under the trade designation “4d T-196” from Fibervisions Inc, Covington, Ga., were formed into a continuous sheet of fibers having a basis weight prior to corrugation of 25 grams per square meter, wherein the majority of the fibers were oriented in the machine direction. The continuous sheet of fibers were formed using a carding machine, model number “SSC4-5PP” obtained from Spinnbau GmbH, Bremen, Germany.

The sheet of fibers was fed into the nip between a pair of corrugating rollers and shaped to form, along the length of the sheet of fibers, about 10 loop portions per 2.54 cm centimeter of sheet length. The first corrugating roller was at a temperature of 150° F. (65° C.), and the second roller temperature was 150° F. (65° C.). Each loop portion was about 0.25 cm high and about 0.18 centimeter long along the length of the sheet of fibers, with about 10 anchor portions each about 0.076 centimeter long. The formed sheet of fibers had a basis weight of 28 grams per square meter. Polypropylene, commercially available under the trade designation “7C50” from Dow Chemical Company, Midland, Mich., was extruded through a die at a die temperature of 480° F. (248.9° C.), and onto the anchor portions of the formed sheet of fibers just prior to the nip between the second corrugating roller and a cooling roller at a temperature of about 85° F. (29.4° C.). The thermoplastic polypropylene backing layer was about 0.0381 centimeter thick, with the anchor portions of the formed sheet of fibers embedded therein. The resultant sheet of loop material was easily and firmly engaged by the hook material of the type described in U.S. Pat. No. 5,845,375 (Miller et al.)

A web of the protection sheet backing material was subjected to corona discharge treatment in an essentially nitrogen atmosphere on the extruded film side, that is, a maximum of 100 ppm oxygen. During corona treatment, the extruded film side of the material was held in contact with a 25 cm diameter, 50 cm face-width, chrome coated steel ground roll. The powered electrode consisted of two 2.5 cm diameter fluid cooled ceramic tube discharge electrodes separated from the ground roll by an electrode gap of 1.5 mm. The corona energy was fixed at 2.0 J/cm², corresponding to a corona power of 750 W at a film speed of 5 meters/min. The corona treater was contained in a housing through which nitrogen was made to continually flow at a rate of with 1000 liter/min. (cryogenically derived nitrogen gas), which maintained the concentration of molecular oxygen in the treater at <10 ppm. The moisture concentration within the housing remained below 200 ppm throughout the treatment process. The nitrogen flow through the housing was maintained for approximately 40 minutes prior to the startup of treating in order to reduce the ambient water content within the housing to below about 200 ppm.

The sample prepared as above had a wetting tension of 42 dynes/cm as measured according to ASTM D 2578-04. By comparison, an untreated sample had a wetting tension of less than 34 dyne/cm.

Both the corona treated and untreated masking materials were spray coated with either primer (Example 1 and Comparative A), clearcoat (Example 2 and Comparative B) or basecoat (Example 3, Comparative C) formulations and allowed to dry. A ¾ inch (19.1 mm) wide strip of adhesive tape, commercially available under the trade designation “Scotch Automotive Refinish Masking Tape 233+” from 3M Company, St. Paul, Minn., was pressed onto the painted surface. The peel force required to remove the adhesive tape was measured on a peel/slip tester, model number “3M90”, commercially available as model number “SP-101B”, from Instrumentors, Inc., Strongsville, Ohio. Peel time was 10 seconds at a peel angle of 180°. The amount of coated material removed by the adhesive tape was visually estimated. Results of the tests, run in triplicate, are listed in Table 1.

TABLE 1

| | | | Average | Amount of |
|---|---|---|---|---|
| | Corona | | Peel Force | Coating |
| Sample | Treated | Coating | (N/cm) | Removed (%) |
| Example 1 | Yes | PR1 | 1.459 | 0 |
| Comparative | No | PR1 | 0.117 | 95 |
| A | | | | |
| Example 2 | Yes | CC1 | 0.857 | <5 |
| Comparative | No | CC1 | 0.102 | 100 |
| B | | | | |
| Example 3 | Yes | BC1 | 0.905 | <5 |
| Comparative | No | BC1 | 0.088 | 100 |
| C | | | | |

What is claimed is:

1. A method of protecting a substrate comprising:
providing at least one fastener adhered to the substrate said fastener having at least one mechanical mating member;
providing a protection sheet, which comprises a backing layer and a support layer, wherein the backing layer is characterized by a wetting tension of at least 35 dynes/cm, and the support layer is characterized by a plurality of anchor portions bonded to the protection sheet and a plurality of raised portions, raised from the surface of the backing layer by comparison to the anchor portions, said raised portions having surface features that can releasably engage or interlock with the mechanical mating member of the fastener;
adhering the support layer of the protection sheet to the mechanical mating member of the fastener to cover the substrate.

2. The method of claim 1, wherein the mechanical mating member is selected from a plurality of fibers and a plurality of stems, and the raised portions of the support layer comprise surface features selected from a plurality of fibers and a plurality of stems.

3. The method of claim 1, wherein the backing layer comprises a polymer surface that has been treated by a process selected from flame treatment, corona treatment, and treatment with liquid or polymeric coatings.

4. The method of claim 3, wherein the corona treatment is a nitrogen corona treatment.

5. A method of protecting a substrate comprising:
providing a fastener having a front surface and an opposing back surface,
said front surface of the fastener having a plurality of outwardly projecting hook members, said back surface of the fastener having an adhesive layer;
adhering the back surface of the fastener to the substrate;
providing a protection sheet of material, said protection sheet having a multi-layer structure comprising a support layer and an opposing backing layer;
said support layer including a plurality of longitudinally oriented fibers having anchor portions and raised portions projecting in a direction away from the anchor portions,
said backing layer is adhered onto the anchor portions of the fibers to bond the anchor portions such that the longitudinally oriented fibers of the support layer are adhered to the backing layer in a corrugated fashion, said backing layer having a wetting tension of at least 35 dynes/cm; [Surface tension is normally a characteristic of liquids. Liquids with high surface tension tend to bead up when dropped onto a surface. Liquids with low surface tension tend to spread out or wet out. Are you certain that surface tension is the correct characterization of the backing layer?]
adhering the support layer of the protection sheet of material to the hook members of the fastener to cover the substrate.

6. The method of claim 5, wherein the backing layer comprises a polymer surface that has been treated by a process selected from flame treatment, corona treatment, and treatment with liquid or polymeric coatings.

7. The method of claim 6, wherein the surface treatment is a nitrogen corona treatment.

8. A method of protecting a substrate comprising:
providing a protection sheet, having a multi-layer structure comprising an support layer and an opposing backing layer,
said support layer including a plurality of fibers having anchor portions and raised portions projecting in a direction away from the anchor portions,
said backing layer being adhered to the anchor portions of the fibers to bond the anchor portions such that the fibers of the support layer are adhered to the backing layer in a corrugated fashion;
covering the substrate with the protection sheet.

9. The method of claim 8, wherein the substrate is covered with the protection sheet with support layer outwardly exposed.

10. The combination of a substrate and a protection sheet fastened to the substrate, comprising:
the substrate;
at least one fastener adhered to the substrate said fastener having at least one mechanical mating member; and
the protection sheet, which comprises a backing layer and a support layer, the backing layer characterized by a wetting tension of at least 35 dynes/cm, and the support layer being characterized by a plurality of anchor portions bonded to the protection sheet and a plurality of raised portions, raised from the surface of the backing layer by comparison to the anchor portions, said raised portions having surface features that can releasably engage or interlock with the mechanical mating member of the fastener causing the protection sheet to adhere to the fastener.

11. The combination of claim 10 wherein:
the mechanical mating member of the fastener is selected from a plurality of fibers and a plurality of stems; and
the raised portions of the support layer comprise surface features selected from a plurality of fibers and a plurality of stems.

12. The combination of claim 10, wherein the backing layer comprises a polymer surface that has been treated by a process selected from corona treatment, flame treatment, and treatment with liquid or polymeric coatings.

13. The combination of claim 12, wherein the process is a nitrogen corona treatment.
